(19) United States
(12) Patent Application Publication
(10) Pub. No.: US 2004/0248585 A1
(43) Pub. Date: Dec. 9, 2004

(54) Method and apparatus for communication frequency determination

(76) Inventor: Ulun Karacaoglu, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/455,193

(22) Filed: Jun. 4, 2003

(51) Int. Cl. H04Q 7/20

(52) U.S. Cl. 455/456.1

(57) ABSTRACT

Numerous embodiments of a method and apparatus for communication frequency determination are disclosed. In one embodiment, a method for communication frequency determination comprises at least partially determining the location of a wireless device, determining one or more wireless network frequencies based at least in part on the location, and scanning at least a portion of the one or more wireless network frequencies. In certain embodiments, the location may comprise a geographic location, and may be determined by a positioning device, such as a geographic positioning system (GPS), for example, which may be an integrated GPS in one embodiment, where the GPS receiver is integrated into the wireless device, for example.

### BACKGROUND

A device that is capable of accessing a wireless network may have a limited power source. Significant power may be consumed by the device when determining the frequency where a particular wireless network is operating. A need exists, therefore, for a method and apparatus of communication frequency determination, which may result in a reduction of power consumption for the device, for example.

### BRIEF DESCRIPTION OF THE DRAWINGS

The subject matter regarded as embodiments of the claimed subject matter is particularly pointed out and distinctly claimed in the concluding portion of the specification. Embodiments of the claimed subject matter, however, both as to organization and method of operation, together with objects, features, and advantages thereof, may best be understood by reference to the following detailed description when read with the accompanying drawings in which:

FIG. 1 is a wireless system suitable for practicing one embodiment of the claimed subject matter;

FIG. 2 is chart of the worldwide frequency band, which may be used in accordance with one embodiment of the claimed subject matter; and

FIG. 3 is a logical flow diagram of one embodiment of a method and apparatus for power management in accordance with one embodiment of the claimed subject matter.

### DETAILED DESCRIPTION

Particular embodiments may comprise a method and apparatus for communication frequency determination. The communication frequency may comprise a frequency that may be used by a mobile wireless device for wireless communications, for example, and a particular frequency may additionally be referred to as a channel. In this context, a mobile wireless device may include devices, such as laptop computers, handheld computers or personal digital assistants (PDAs), which are configured to transmit data signals at one or more channels or frequencies. Devices such as those described typically include an interface for accessing a wireless network, such as a receiver or transceiver, also referred to herein as a network interface card (NIC), but it is important to note that certain embodiments are not so limited. A wireless network, in this context, may comprise two or more devices capable of sending and/or receiving wireless data with each other. One particular type of device may comprise a WLAN access point (AP). A WLAN AP, in one embodiment, may comprise a device that is located in a fixed location, that may provide connectivity to a wireless network, and may provide access to the internet or an intranet, for example. Alternatively, a WLAN AP may not connect directly to the internet or an intranet, but may provide a gateway to another access point, for example.

Devices such as those described may communicate by use of radio frequency communication or infrared frequency communication, for example, although certain embodiments are not limited to a particular medium. Examples of types of wireless networks that may use varying media may include, for example, Bluetooth, IrDA (Infrared data association), HomeRF or Wi-Fi. Wireless networks may typically utilize one or more communications protocols, such as the IEEE 802.1 1 family of standards, (Standards for Information Technology—Telecommunications and Information Exchange between Systems—Local and Metropolitan Area Network—Specific Requirements—Part 11: Wireless LAN Medium Access Control (MAC) and Physical Layer (PHY) Specifications, ANSI/IEEE Std. 802.11 -1999, hereinafter “802.11”. However, those of skill in the art will be aware that the claims subject matter is not limited to any particular specification or standard.

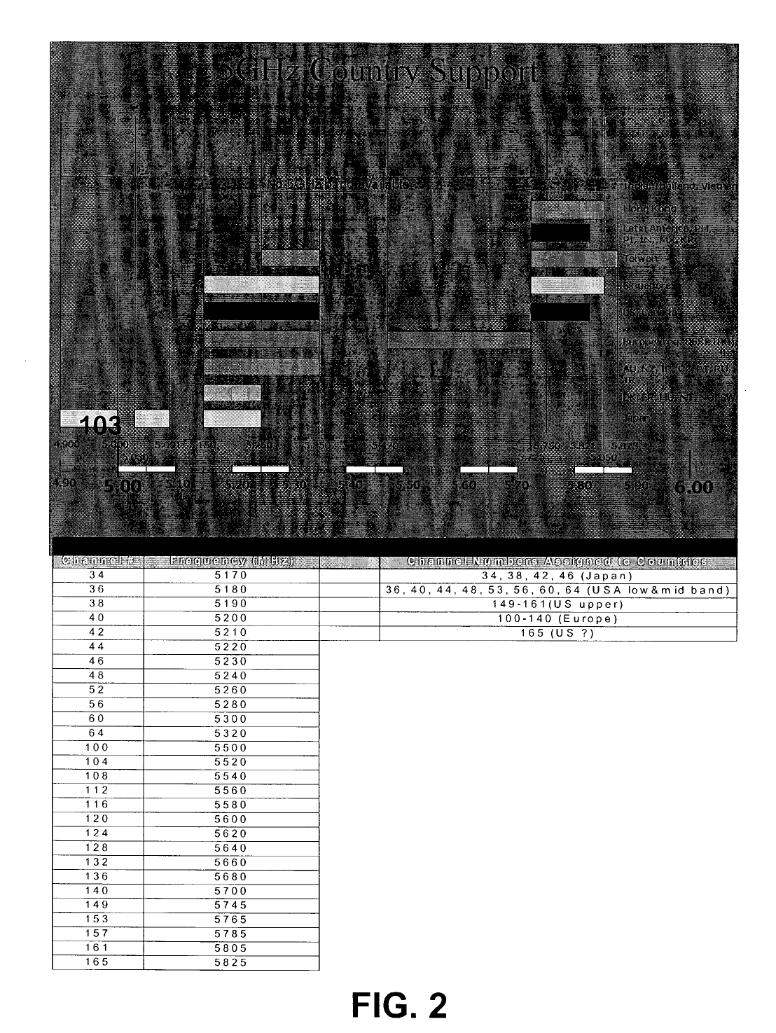

Mobile wireless devices such as those described above may first perform scanning in order to be capable of sending and/or receiving wireless data. The scanning may comprise scanning of multiple frequencies or channels. The scanning may be used to determine which frequency a wireless network is operating on. In one embodiment, scanning may comprise incrementally checking a set of channels for an active wireless network, such as checking all the channels assigned to the United States, for example, as explained in more detail in reference to FIG. 2. Once the scanning process is performed and a functional wireless network is detected, the device may achieve association, and may subsequently be connected to the wireless network. In this context, a connection to a wireless network may alternatively be referred to as a network session.

One embodiment may comprise at least partially determining the location of a wireless device, determining one or more wireless network frequencies based at least in part on the location, and scanning at least a portion of the one or more wireless network frequencies. In certain embodiments, the location may comprise a geographic location, and may be determined by a positioning device, such as a geographic positioning system (GPS), for example, which may be an integrated GPS in one embodiment, where the GPS receiver is integrated into the wireless device, for example.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Numerous specific details may be set forth herein to provide a thorough understanding of certain embodiments. It will be understood by those skilled in the art, however, that particular embodiments may be practiced without these specific details. In other instances, well-known methods, procedures, components and circuits have not been described in detail so as not to obscure particular embodiments. It can be appreciated that the specific structural and functional details disclosed herein may be representative and do not necessarily limit the scope of the claimed subject matter.

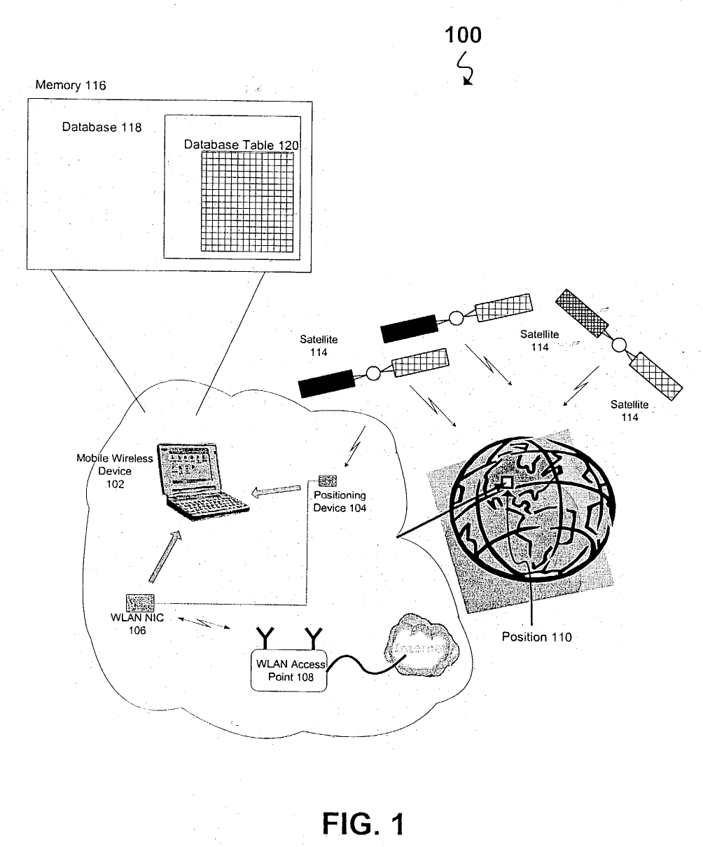

Referring now in detail to the drawings wherein like parts are designated by like reference numerals throughout, there is illustrated in FIG. 1 a system 100. Shown in FIG. 1 is a system 100 illustrating a mobile wireless device coupled to a network. Wireless device 102 may comprise a device capable of accessing a network such as a wireless network, as described previously. Mobile wireless device 102 may be coupled to a transceiver or network interface card (NIC) 106, which may be capable of sending and/or receiving wireless communications across a wireless network, for example. Mobile wireless device 102 may be coupled to a positioning device 104, such as a geographic positioning system (GPS), and may be coupled to positioning device 104 at least partially through NIC 106, for example. NIC 106 may be capable of sending and/or receiving data with access point (AP) 108, which may comprise a WLAN access point, for example. One or more communications media may be used to send and/or receive data between NIC 106 and AP 108, as described previously. AP 108 may be capable of accessing a network such as the internet.

In operation, positioning system 104 may receive information relating to the geographic location 110 of the positioning device and/or NIC 106 and/or mobile wireless device 102. This information relating to the geographic location 110 may be based at least in part on information received from satellites 114, for example, although the claimed subject matter is not limited to the use of only 3 satellites, or the use of satellites at all for determining geographic location information. Geographic location information may be at least partially communicated from positioning device 104 to NIC 106 and/or mobile wireless device 102, for example. This information may be in the form of geographic coordinates, location, country, or other location information, for example. This information may be at least partially utilized by the mobile wireless device 102 and the NIC 106 to determine which frequency or range of frequencies wireless AP may be operating. This may be performed by accessing one or more database such as database 118, which may contain one or more tables such as database table 120, and may be stored in memory 116 of mobile wireless device 102. Database table 120 may contain information relating to frequencies of particular geographic locations. Information in a database such as database table 120 may be used in the following manner: positioning system 104 may communicate positioning information to mobile wireless device 102, such as the geographic location. Device 102 may access database table 120, and may cross reference the geographic location to determine a group of channels associated with the location. Device 102 may then instruct NIC 106 to scan the group of channels to determine if any wireless networks are functional. Information contained in database table 120 may be all or a portion of the information illustrated in FIG. 2, for example.

FIG. 2 illustrates the worldwide frequency range, which depicts the frequency spectrum that wireless devices may operate in particular countries. Additionally, illustrated are the associated channels, on which wireless data transmission may be performed within the particular countries. As shown in FIG. 2, most countries operate in a plurality of channels and in a plurality of frequencies, and the geographic frequency band ranges from 4.9-5.85 GHz, and spans more than 28 channels. As just an example, as shown in FIG. 2, a device operating within the geographic borders of the United States may operate within a frequency of 5.15 to 5.35 GHz, or 8 channels. In at least one embodiment, all or a portion of the information contained in FIG. 2 may be stored in one or more databases that may be accessed by a mobile wireless device or device coupled to a mobile wireless device, such as database table 120 of FIG. 1, for example. The database(s) may be arranged in any manner, such as by country, by frequency band, or by geographic coordinates, for example, but certain embodiments are not so limited. Organization and content of the database(s) may be in any manner that provides the capability to find information relating to operating frequencies or channels based on one or more criteria, such as geographic location, for example.

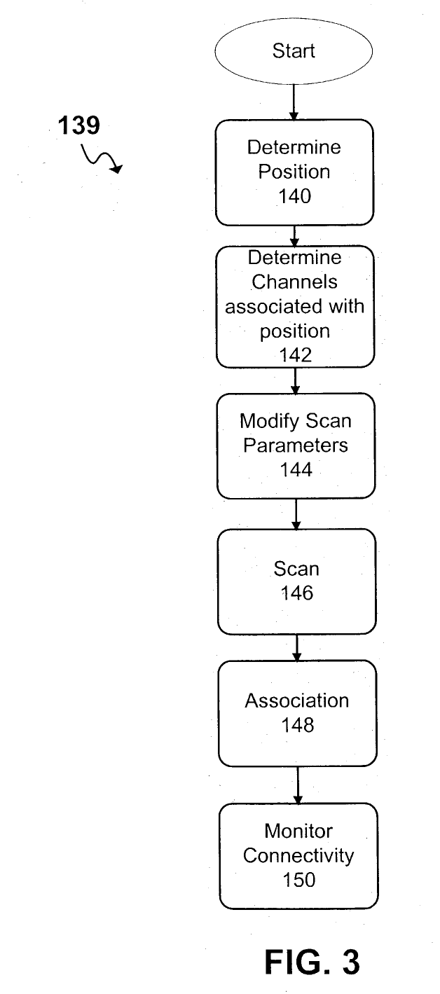

FIG. 3 is a block flow diagram of programming logic performed according to one embodiment. In this embodiment, either the software and/or hardware of one or more of the described devices, such as the NIC or the mobile device, for example, may be used to implement the functionality of one or more blocks as described herein. It can be appreciated that this functionality, however, may be implemented by a device, or combination of devices, located anywhere in a communication network or system and still fall within the scope of at least one embodiment. For example, all or a portion of the functions disclosed herein may be performed by a wireless device, or may be performed by a network interface device such as a NIC, for example. One or more processors coupled to the wireless device may execute one or more of the functions embodied as machine-readable media, such as software. The processor that executes the machine-readable media may be a general-purpose or dedicated processor, such as a processor from the family of processors made by Intel Corporation, for example. The machine-readable media may comprise programming logic, instructions or data to implement certain functionality for one or more embodiments. The machine-readable media may be stored as software, accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment, the media may store programming instructions in a compressed and/or encrypted format, as well as instructions that may have to be compiled or installed by an installer before being executed by the processor. Alternatively, an embodiment may be implemented as specific hardware components that contain hard-wired logic for performing the recited functionality, or by any combination of programmed general-purpose computer components and custom hardware components.

In operation, an implementation of programming logic illustrated by logical flow diagram 139 of FIG. 3 may perform the following functions, but the order presented does not infer a particular order of execution of the following functions when implemented. The location of a mobile wireless device may at least partially determined at block 140, which may comprise a geographic location. In the case of partial determination of location, the location may be approximated or may be estimated, rather than precisely determined. The wireless channels or frequencies associated with the location may be determined at block 142. The parameters of a channel or frequency scan for a wireless device may be altered at block 144. The wireless device may scan based at least in part on the altered parameters at block 146. Association, or connectivity, may be made after a scan at block 148, and the connectivity may be monitored at block 150. One or more of these functions may be repeated if, for example, connectivity is lost or if the device moves to another location.

In one embodiment, determining location may comprise determining the location of a mobile wireless device, which may be configured to access a wireless network by use of a transceiver such as a network interface card, for example. Alternatively, the location of the transceiver may be determined, if it is at a location differing from the mobile wireless device that is using the transceiver for access to a network. In this embodiment, the location may be determined by use of a GPS system. The GPS system may be integrated into the device, and may supply coordinates or other information allowing the device to access a database of frequency bands correlating to a location, for example. Alternatively, the location may be entered by a user, and may be in the form of a country code or coordinates, for example.

In operation, positioning system 104 may comprise a GPS system, and may receive information relating to the geographic location 110 of the positioning device and/or NIC 106 and mobile wireless device 102. This information relating to the geographic location 110 may be based at least in part on information received from satellites 114, but embodiment are not limited to the use of 3 satellites, or the use of satellites at all for determining geographic location information. Geographic location information may be at least partially communicated from positioning device 104 to NIC 106 and/or mobile wireless device 102, for example. This information may be in the form of geographic coordinates, location, or other location information, for example. This information may be at least partially utilized by the mobile wireless device 102 and the NIC 106 to determine which channel(s) wireless AP may be operating. NIC 106 may perform scanning on at least a portion of the frequency bands in order to establish connectivity or association.

In one embodiment, determining channels associated with position may comprise using information obtained in reference to geographic location, and using this information to access a database of channels indicating what frequency or range of frequencies may be used to send and/or receive wireless communications within the location determined. A database may contain information such as the tables of FIG. 2, for example, and may allow a lookup of frequency ranges based on a country determined in functional block 140 of FIG. 3.

In one embodiment, modifying scan parameters may comprise using information obtained from the channel determination to modify the channels scanned when a device is attempting to find a wireless network. The scan parameters may be changed to include scanning of only the channels used in the country where the device was determined to be located, for example, or may be a subset of that group of channels, for example. Any modification of scan parameters that results in an alteration of the scan parameters from scanning of the entire frequency range for wireless devices may be in accordance with at least one embodiment.

In one embodiment, scanning may comprise a process to determine where wireless access may be obtained, and may comprise an attempt to achieve association with a wireless network by scanning for activity on a particular channel, which may comprise a frequency within the parameters determined based on device location, for example, and if connectivity or association is not obtained, the channel scanned may be increased incrementally until association is achieved, for example.

In one embodiment, association may comprise the discovery of an operating wireless network, and connectivity to that network. In this context, connectivity is not necessarily physical connectivity, but may include logical connectivity or partial connectivity, for example. Any sort of connection that allows a device to send and/or receive information on a network may be considered association in at least one embodiment.

In one embodiment, monitoring connectivity may comprise a determination of whether association still exists for a device after a particular period of time, such as in increments of minutes or seconds, for example. If connectivity is lost, one or more of the functions of logical flow diagram 139 may be repeated, for example. The connectivity monitoring may be performed by a mobile wireless device, a NIC, or may be performed by a user, for example, who may indicate that association is lost and a new scanning process may be desirable.

In one exemplary embodiment, a method and apparatus for wireless device management may proceed as follows: A mobile wireless device, such as a laptop computer, may be coupled to a wireless network interface card, that is capable of sending and receiving data by use of radio waves. The laptop computer may determine that there is no connectivity to a wireless network, and may instruct a GPS to determine geographic location. A GPS may perform positioning functions, and may provide the laptop computer with geographic coordinates. The laptop computer may utilize the geographic coordinates to determine country location, by use of a database containing countries and associated channels, for example. The laptop computer may determine what channels a wireless network may be operating within in the determined country. The laptop computer may instruct the NIC to scan only within the channels used by the particular country. The NIC may scan all or a portion of the channels determined by the laptop computer, and may find a channel, or frequency, where a wireless network is operating. The NIC may perform connectivity functions, and may achieve association with the wireless network. As stated previously, this functionality may provide that scanning requires scanning fewer than all the geographic frequency ranges, which may result in faster time to associate, and may additionally use less power, and result in prolonged battery life for a laptop operating on battery power, for example.

It can be appreciated that the embodiments may be applied to any network node at any level within a network hierarchy. Additionally, certain features of the embodiments have been illustrated as described herein, however, many modifications, substitutions, changes and equivalents will now occur to those skilled in the art. It is, therefore, to be understood that the appended claims are intended to cover all such modifications and changes as fall within the true spirit of the embodiments of the claimed subject matter.

1. A method of connecting to a wireless network, comprising:
at least partially determining the location of a wireless device;
determining one or more wireless network frequencies based at least in part on the location; and
scanning at least a portion of the one or more wireless network frequencies.

2. The method of claim 1, wherein said determining comprises receiving information from a plurality of satellites relating to geographic location.

3. The method of claim 2, wherein said plurality of satellites comprises a geographic positioning system (GPS).

4. The method of claim 2, wherein said information comprises coordinates where the wireless device is located.

5. The method of claim 1, wherein said determining one or more wireless network frequencies comprises using the determined location to reference a database containing wireless network frequencies of particular locations.

6. The method of claim 1, wherein said scanning further comprises scanning only wireless network frequencies that may be used in a particular location.

7. A method of connecting to a wireless network, comprising:
receiving information relating to the geographic location of a wireless device;
scanning one or more wireless network channels based at least in part on said information.

8. The method of claim 7, wherein the information comprises geographic coordinates.

9. The method of claim 7, wherein the information comprises a country.

10. The method of claim 7, wherein said scanning is performed on one or more channels on which a wireless device is capable of communicating with one or more additional wireless devices in that country.

11. A system, comprising:
a receiver to receive positioning information; and
a transmitter to transmit positioning information, said receiver and said transmitter configured such that, in operation, said transmitter is capable of providing positioning information to said receiver, and said receiver is capable of using said positioning information to at least partially determine a frequency range being used to operate a wireless network in that location.

12. The system of claim 11, wherein the receiver comprises a device capable of one of sending and receiving wireless information

13. The system of claim 12, wherein said receiver comprises a laptop computer.

14. The system of claim 11, wherein said positioning information comprises geographic coordinates.

15. The system of claim 11, wherein the receiver comprises a network interface card (NIC).

16. The system of claim 11, wherein said receiver comprises a wireless router.

17. An apparatus, comprising:
circuitry to receive information relating to the geographic location of at least a portion of the circuitry, and determine one or more wireless device frequencies, based at least in part upon the geographic location of the circuitry.

18. The apparatus of claim 17, wherein the circuitry comprises a device capable of one of sending and receiving wireless information.

19. The apparatus of claim 17, wherein the circuitry comprises a laptop computer.

20. The apparatus of claim 17, wherein the circuitry comprises a network interface card (NIC).

21. The apparatus of claim 17, wherein the circuitry comprises a wireless router.

22. A machine-readable medium, having stored thereon instructions, that when executed by a computing system cause the computing system to:
receive information relating to the geographic location of a wireless device;
scan one or more wireless network channels based at least in part on said information.

23. The machine-readable medium of claim 22, wherein the information comprises geographic coordinates.

24. The machine-readable medium of claim 22, wherein the information comprises a country.

25. The machine-readable medium of claim 22, wherein said scanning is performed on one or more of the channels in which a wireless device is capable of communicating with one or more additional wireless devices in that country.
